(19) United States
(12) Patent Application Publication
(10) Pub. No.: US 2015/0205058 A1
(43) Pub. Date: Jul. 23, 2015

(54) OPTICAL COUPLING LENS AND OPTICAL FIBER COUPLING CONNECTOR

(71) Applicant: HON HAI PRECISION INDUSTRY CO., LTD., New Taipei (TW)

(72) Inventor: CHANG-WEI KUO, Tu-Cheng (TW)

(21) Appl. No.: 14/546,163

(22) Filed: Nov. 18, 2014

(30) Foreign Application Priority Data
Jan. 23, 2014 (TW) 103102438

(51) Int. Cl. G02B 6/42; G02B 6/32; G02B 6/43; G01J 1/04

(52) U.S. Cl. CPC G02B 6/425; G01J 1/0411; G01J 1/0425; G01J 1/0414; G02B 6/322; G02B 6/4214; G02B 6/423; G02B 6/426; G02B 6/43

(57) ABSTRACT

An optical coupling connector includes an optical coupling lens, a circuit board, optical fibers, light receiving devices, and light emitting devices arranged on the circuit board. The optical coupling lens is fixed on the circuit board. The optical coupling lens includes a main body, a plurality of converging lenses, and a cover. The main body includes a first groove and second groove. The optical fibers are fixed by the first groove and the cover. The second groove has an oblique reflection surface to change the light direction. The plurality of converging lenses is fixed on a bottom of the main body and respectively aligned with the plurality of light receiving devices and the plurality of light emitting devices. The optical coupling lens converts electrical signals from light emitting devices to optical signals for optical fibers, and converts light signals from optical fibers to electrical signals for the light receiving devices.

### FIELD

The subject matter herein generally relates to data transmission.

### BACKGROUND

An optical coupling lens of an optical fiber coupling connector is used to connect with an optical fiber accommodating device using optical fibers, and the optical fiber couples with a light emitting device and a light receiving device through the optical coupling lens. The optical coupling lens and the optical fiber accommodating device are generally separated structures. The integration of the optical coupling lens with the optical fiber accommodating device results in a complicated structure.

### BRIEF DESCRIPTION OF THE DRAWING

Many aspects of the disclosure can be better understood with reference to the following drawing. The components in the drawing are not necessarily drawn to scale, the emphasis instead being placed upon clearly illustrating the principles of the disclosure. Implementations of the present technology will now be described, by way of example only, with reference to the attached figure.

FIG. 1 is an isometric, perspective view of an optical fiber coupling connector according to the present disclosure.

FIG. 2 is an isometric, exploded view of an optical fiber coupling connector in FIG. 1 according to the present disclosure.

FIG. 3 is an isometric, perspective view of an optical coupling lens of the optical fiber coupling connector of FIG. 2.

FIG. 4 is a diagrammatic sectional view of an optical fiber coupling connector along a line IV-IV of FIG. 1.

### DETAILED DESCRIPTION

An optical fiber coupling connector with a optical coupling lens is described. The disclosure is illustrated by way of example and not by way of limitation in the accompanying drawing. It should be noted that references to “an” or “one” embodiment in this disclosure are not necessarily to the same embodiment, and such references mean “at least one.”

Several definitions that apply throughout this disclosure will now be presented. The term “substantially” is defined to be essentially conforming to the particular dimension, shape, or other feature that the term modifies, such that the component need not be exact. For example, “substantially cylindrical” means that the object resembles a cylinder, but can have one or more deviations from a true cylinder. The term “comprising,” when utilized, means “including, but not necessarily limited to”; it specifically indicates open-ended inclusion or membership in the so-described combination, group, series, and the like.

An optical coupling lens includes a main body, a plurality of converging lenses, and a cover. The main body includes a top surface, a bottom surface, a front surface, a rear surface, a lower surface, an inner surface, a reflection surface and an optical surface. The top surface is opposite to the bottom surface. The front surface is opposite to the rear surface. The front surface and the rear surface are perpendicularly interconnected between the bottom surface and the top surface. The bottom surface defines a bottom groove. The top surface defines a first groove and a second groove. The first groove and the second groove are separated by a separating portion (not shown). The lower surface is located at a bottom of the first groove. The inner surface is located in the first groove and perpendicularly extends from the lower surface. The reflection surface is located in the second groove. The inner surface and the reflection surface are positioned at opposite sides of the separating portion. The lower surface defines a plurality of receiving grooves for receiving a plurality of optical fibers. The cover is received in the first groove and retains the optical fibers in the receiving grooves. The optical surface is located at a bottom of the bottom groove. The converging lenses are arranged on the optical surface and correspond to the optical fibers through the reflection surface.

An optical fiber coupling connector comprises the optical coupling lens as described above, and a circuit board, a plurality of light emitting devices, a plurality of light receiving devices, and a plurality of optical fibers. The optical coupling lens is fixed on the circuit board. The plurality of the light emitting devices and the plurality of light receiving devices are fixed on the circuit board and accommodated within the bottom groove. The plurality of light emitting devices and the plurality of light receiving devices are respectively aligned with the plurality of converging lenses. The plurality of optical fibers are received in the plural of receiving grooves.

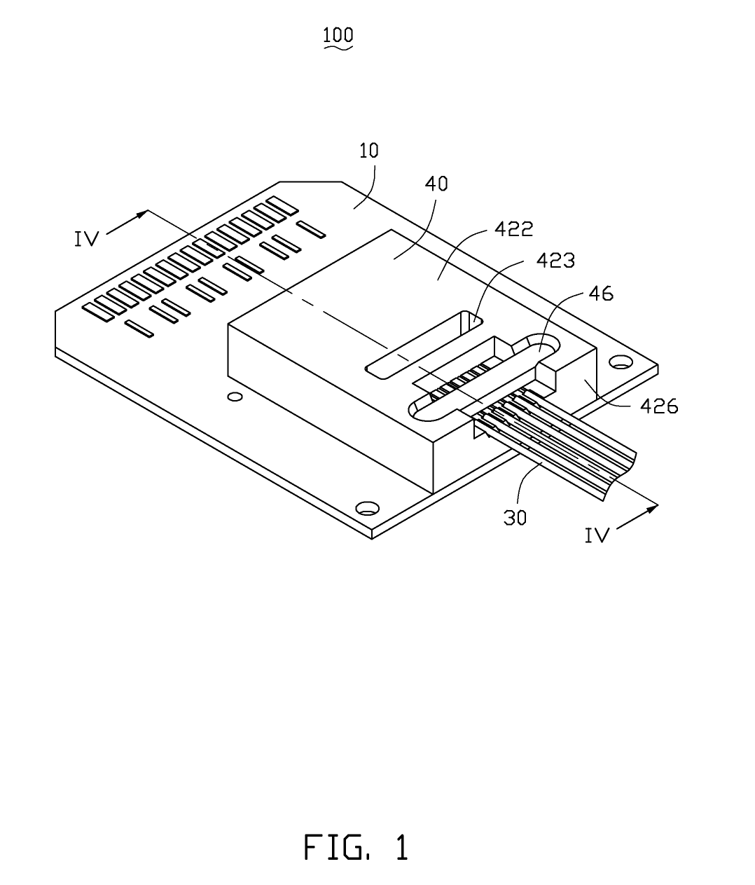

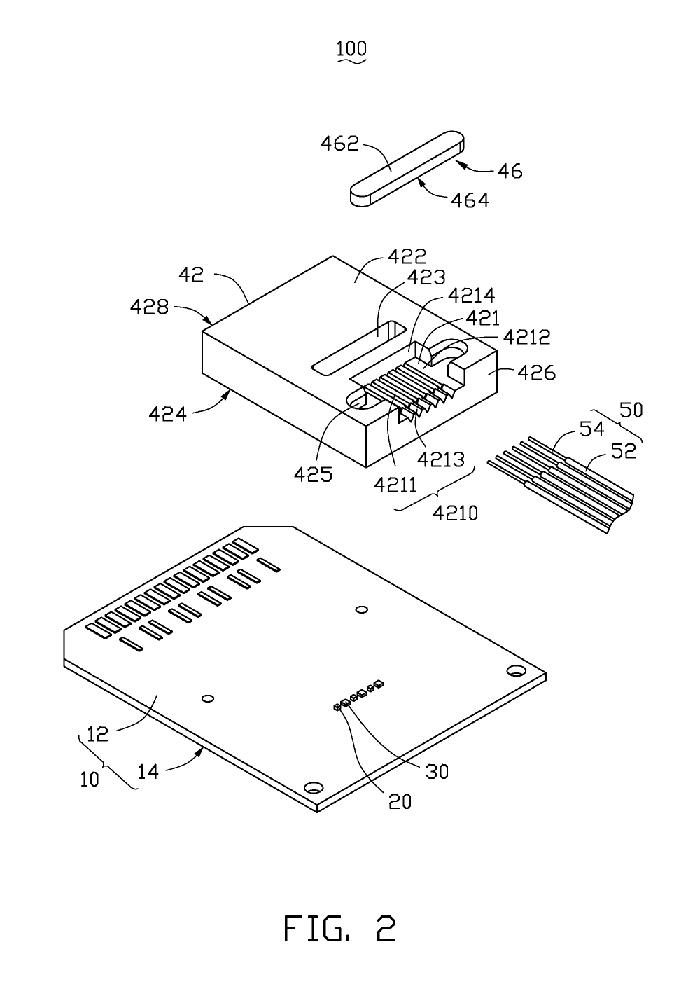

FIG. 1 and FIG. 2 show an isometric view and an exploded view of an optical fiber coupling connector. The optical fiber coupling connector includes a circuit board 10, three light emitting devices 20, three light receiving devices 30, an optical fiber coupling lens 40, and six optical fibers 50.

The circuit board 10 includes an front-side circuit surface 12 and a back-side circuit surface 14. The front-side circuit surface 12 and the back-side circuit surface 14 are located on opposite sides of the circuit board 10 and are parallel to each other.

The three light-emitting devices 20 and the three light receiving devices 30 are alternately spaced on the front-side circuit surface 12 of the circuit board 10. Specifically, the three light-emitting devices 20 and the three light receiving devices are uniformly arranged along a first straight line. In this embodiment, the three light emitting devices 20 can be vertical-cavity surface emitting laser diodes, which are used to convert electrical signals to light signals and to emit light outward. The three light receiving devices 30 receive light from outside and convert light signals to electrical signals.

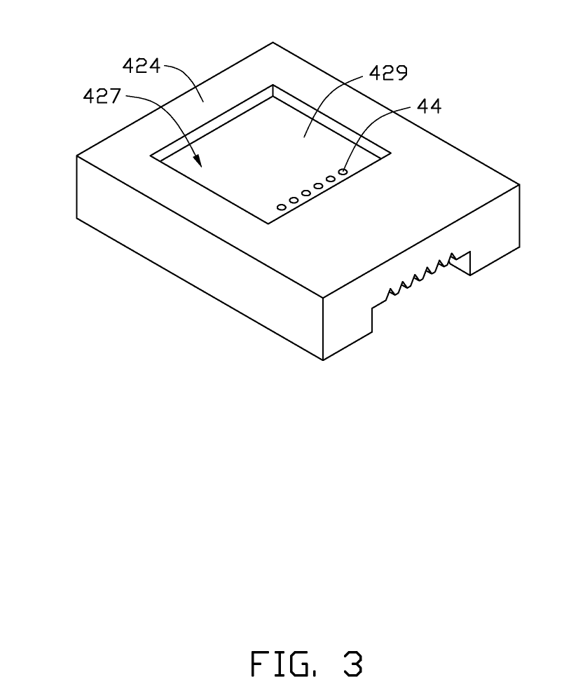

Referring to FIG. 2 and FIG. 3, the optical coupling lens 40 includes a main body 42, six converging lenses 44, and a cover 46. The main body 42 is substantially a rectangular parallelepiped structure and comprises a top surface 422, a bottom surface 424, a front surface 426, and a rear surface 428. The top surface 422 and the bottom surface 424 are located on opposite sides of the main body 42, and the top surface 422 and the bottom surface 424 are parallel. The front surface 426 and the rear surface 428 are located on opposite sides of the main body 42, and are parallel to each other. The front surface 426 is perpendicularly connected to the top surface 422 and the bottom surface 424, and the rear surface 428 is perpendicularly connected to the top surface 422 and the bottom surface 424.

The top surface 422 has a rectangular-shaped first groove 421, a strip-shaped second groove 423, and a strip-shaped third groove 425. The first groove 421 and the second groove 423 are separated by a separation portion 48, the third groove 425 is across the first groove 421, and both ends of the third groove 425 extend through opposite sides of the first groove 421. The ends of the third groove 425 are symmetrical about the first groove 421.

The first groove 421 includes a lower surface 4212 and an inner surface 4214, the lower surface 4212 has six parallel V-shaped receiving grooves 4210 uniformly arranged and each receiving groove 4210 includes a first receiving section 4211 and a second receiving section 4213. The first receiving section 4211 and the second receiving section 4213 are arranged from the inner surface 4210 to the front surface 426. The shape of the first receiving section 4211 and the second receiving section 4213 can be semicircular or V-shaped. In this embodiment, the first receiving section 4211 and the second receiving section 4213 are V-shaped.

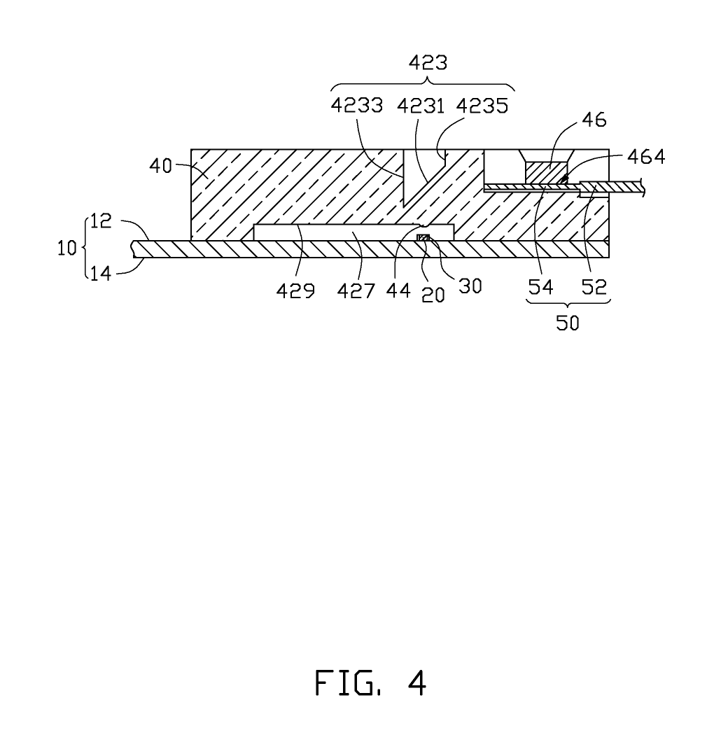

Referring to FIG. 4, the second groove 423 includes a reflection surface 4231, a first side surface 4233, and a second side surface 4235. The first side surface 4233 and the second side surface 4235 are located on opposite sides of the second groove 423, and the first side surface 4233 and the second side surface 4235 are perpendicularly connected to the top surface 422. The reflection surface 4231 obliquely connects with the first side surface 4233 and the second side surface 4235. The angle between the reflection surface 4231 and the inner surface 4214 is 45 degrees.

Referring to FIG. 3, the bottom surface 424 has a rectangular bottom groove 427. The bottom groove 427 includes an optical surface 429. The optical surface 429 is located at the bottom of the bottom groove 427 and parallel to the bottom surface 424. The angle between the optical surface 429 and the reflecting surface 4231 is 45 degrees.

The six converging lenses 44 are formed on the optical surface 429. In this embodiment, the six converging lenses 44 are formed on the reflection surface substantially uniformly and arranged as a second line.

Referring to FIG. 1 and FIG. 2, the cover 46 with an elongated bar shape coincides with the structure of the third groove 425. In the present embodiment, the cover 46 and the third groove 425 are used to fix the six optical fibers 50. The cover 46 may be fixed to the third groove 425 by dispensing glue, engagement structures, or threaded connecting structures. The cover 46 includes a first surface 462 and a second surface 464. The first surface 462 and second surface 464 are located at opposite sides of the cover 46, and the first surface 462 is parallel to the second surface 464.

Referring to FIG. 2 and FIG. 4, the optical fiber 50 includes a cladding layer 52 and a core 54 covered with the cladding layer 52. The core 54 projects from the cladding layer 52. The cladding layer 52 corresponds to the second receiving section 4213, and the core 54 corresponds to the first receiving section 4211.

To assemble the six optical fibers 50 within the first groove 421, first, the six optical fibers 50 are placed within the six receiving grooves 4210 from top to bottom. Specifically, the six cores 54 are received within the first receiving sections 4211, and the cladding layer 52 is received within the second receiving section 4213. Next, the cover 46 is fixed and engaged to the third groove 425. At this time, the first surface 462 can be aligned flush with the top surface 422, or the first surface 462 can be closer towards the lower surface and have a lower location corresponding to the top surface 422. The second surface 464 is in contact with the tangent plane of the six cores 54, therefore, the second surface 464 and each of inclined surfaces of the first receiving section 4211 commonly fix the six optical fibers 50. Finally, the first groove 421 and the third groove 425 are filled in with glue to securely fix the six optical fibers 50 to the six receiving grooves 4210. For the assembling process described above, if the amount of the glue is excessive for fixing the cover 46, the excessive glue can flow into the first groove 421 into a space which is not occupied by the optical fibers 50.

Referring to FIG. 1 and FIG. 2, assembly of the optical fiber coupling connector 100 requires that, first, the three light-emitting devices 20 and the three light receiving devices 30 are mounted on the front-side circuit surface 12. Next, the main body 42 is placed on the front-side circuit surface 12, and the three light-emitting devices 20 and the three light receiving devices 30 are one by one aligned with a converging lens 44. Then, glue is applied to the contact area of the main body 42 and the front-side circuit surface 12 and the surrounding of the contact area to fix the optical converging lenses 40 on the circuit board 10, to complete the assembly of the main body 42. Finally, using the method described above, assembly of the six optical fibers 50 and the main body 42 completes the assembly of the optical fiber coupling connector. At this moment, each of the six converging lenses 44 is aligned with one optical fiber 50.

Referring to FIG. 4, in operation, the light emitted from the three light emitting devices 20 passes through the three converging lenses 44 and is transformed into parallel light to enter the interior of the optical coupling lens 40. The light is then reflected by the oblique reflection surface 4231 and the direction of the light is changed by 90 degrees to enter into the three optical fibers 50. Accordingly, the light from the three optical fibers 50 enters the interior of the optical coupling lens 40 and is reflected by the reflective surface 4231 to change the direction of the light by 90 degrees, and then, the light is converged by the converging lenses 44 to enter the three light receiving devices 30. Finally, the three light receiving devices 30 convert the light signals to electrical signals for subsequent processes.

The number of the light emitting device 20 and the number of the received light device 30 is not limited to three and the number of the converging lens 44 and the number of the optical fiber 50 is not limited to six. The quantities can change according to the needs of the optical coupling lens 40, and for example, may be four, six, eight, or more. The quantity of the light emitting devices 20 and the light receiving devices 30 and the quantity of the converging lenses 44 and the quantity of the optical fibers 50 must be the same. All of the light emitting devices 20 and the receiving devices 30, the converging lenses 44, and the optical fibers 50 correspond one-to-one with each other.

The present embodiment is an optical fiber coupling connector 100 and an optical coupling lens 40 using the cover 46 and the six receiving groove 4210 to fix the six optical fibers 50. The use of an additional receiving device to accommodate the six optical fibers 50 and to increase the degree of integration of the optical coupling lens 40 is avoided, thereby simplifying the structure of the optical coupling lens 40 and the optical fiber coupling connector 100.

The embodiments shown and described above are only examples. Many details are often found in the art such as the other features of an optical coupling lens and an optical fiber coupling connector with the optical coupling lens. Therefore, many such details are neither shown nor described. Even though numerous characteristics and advantages of the present technology have been set forth in the foregoing description, together with details of the structure and function of the present disclosure, the disclosure is illustrative only, and changes can be made in the details, especially in matters of shape, size, and arrangement of the parts within the principles of the present disclosure, up to and including the full extent established by the broad general meaning of the terms used in the claims. It will therefore be appreciated that the embodiments described above can be modified within the scope of the claims.

What is claimed is:

1. An optical coupling lens, comprising:
a main body, comprising a top surface, a bottom surface opposite to the top surface and parallel to the top surface, a front surface, and a rear surface opposite to the front surface and parallel to the front surface;
a plurality of converging lenses; and
a cover,
wherein the front surface and the rear surface are perpendicularly interconnected between the bottom surface and top surface, the bottom surface defines a bottom groove, the top surface defines a first groove and a second groove, the first groove and the second groove are separated by a separating portion, an inner surface is located in the first groove and a reflection surface is located in the second groove, the bottom of the first groove is formed as a lower surface, the inner surface is perpendicular to the lower surface, the lower surface defines a plurality of receiving grooves for receiving a plurality of optical fibers, an optical surface is located at a bottom of the bottom groove, the reflection surface is obliquely corresponding to the optical surface, the plurality of converging lenses are arranged on the optical surface and correspond to the optical fibers through the reflection surface.

2. The optical coupling lens according to claim 1, wherein the top surface further has a third groove across the first groove, both ends of the third groove are respectively extended through the opposite sides of the first groove and are symmetry related to the first groove, the third groove is used to receive the cover and fix the plurality optical fibers within the plurality of receiving grooves.

3. The optical coupling lens according to claim 1, wherein the cover is fixed within the third groove by glue or an engagement structure.

4. The optical coupling lens according to claim 1, wherein each receiving groove comprises a first receiving section and a second receiving section, the first receiving section and the second receiving section are arranged by following a direction from the inner surface to the front surface, the first receiving section is used for receiving the core of the optical fiber and the second receiving section is used for receiving the cladding layer of the optical fiber.

5. The optical coupling lens according to claim 1, wherein the shapes of the first receiving section and the second receiving section are selected from one of semicircular shape or V shape.

6. The optical coupling lens according to claim 1, wherein the main body further comprises a first side surface and a second side surface which are located on opposite sides of the second groove, the first side surface and the second side surface are perpendicularly connected to the top surface, the reflection surface obliquely connects with the first side surface and the second side surface.

7. The optical coupling lens according to claim 6, wherein an angle between the reflection surface and the inner surface is 45 degrees.

8. An optical fiber coupling connector, comprising:
a circuit board;
a plurality of light emitting devices fixed on the circuit board;
a plurality of light receiving devices fixed on the circuit board;
a plurality of optical fibers; and
an optical coupling lens having a main body that includes:
a top surface, a bottom surface opposite and parallel to the top surface, a front surface, and a rear surface opposite and parallel to the front surface, a plane parallel to the front surface and the rear surface being perpendicular to a plane parallel to the bottom surface and top surface;
a plurality of converging lenses; and
a cover,
wherein the bottom surface defines a bottom groove, the top surface defines a first groove and a second groove, the first groove and the second groove are separated by a separating portion, an inner surface is located in the first groove and a reflection surface is located in the second groove, the bottom of the first groove is formed as a lower surface, the inner surface is perpendicular to the lower surface, the lower surface defines a plurality of receiving grooves for receiving a plurality of optical fibers, an optical surface is located at a bottom of the bottom groove, the reflection surface being positioned oblique to the optical surface, the plurality of converging lenses are arranged on the optical surface and correspond to the optical fibers through the reflection surface; and
wherein the optical coupling lens is fixed on the circuit board, the plurality of light emitting devices and the plurality of light receiving devices are received in the bottom groove, the plurality of light emitting devices and the plurality of light receiving devices are aligned with the plurality of converging lens, and the plurality of optical fibers are receiving in the plurality of receiving grooves.

9. The optical fiber coupling connector according to claim 8, wherein the plurality of light emitting devices and the plurality of light receiving devices are arranged in a straight line and correspond to the plurality of the converging lenses.

10. The optical fiber coupling connector according to claim 8, wherein the optical coupling lens is fixed on the circuit board by glue or an engagement structure.

11. The optical fiber coupling connector according to claim 8, wherein the top surface further has a third groove across the first groove, both ends of the third groove are respectively extended through the opposite sides of the first groove and are symmetry related to the first groove, the third groove is used to receive the cover and fix the plurality optical fibers within the plurality of receiving grooves.

12. The optical fiber coupling connector according to claim 8, wherein each receiving groove comprises a first receiving section and a second receiving section, the first receiving section and the second receiving section are arranged by following a direction from the inner surface to the front surface, the first receiving section is used for receiving the core of the optical fiber and the second receiving section is used for receiving the cladding layer of the optical fiber.

13. The optical fiber coupling connector according to claim 8, wherein the shapes of the first receiving section and the second receiving section are selected from one of semicircular shape or V shape.

14. The optical fiber coupling connector according to claim 8, wherein the main body further comprises a first side surface and a second side surface which are located on opposite sides of the second groove, the first side surface and the second side surface are perpendicularly connected to the top surface, the reflection surface obliquely connects with the first side surface and the second side surface.

15. The optical fiber coupling connector according to claim 14, wherein an angle between the reflection surface and the inner surface is 45 degrees.
